(19) United States
(12) Patent Application Publication
(10) Pub. No.: US 2014/0145656 A1
(43) Pub. Date: May 29, 2014

(54) CIRCUIT FOR DETECTING BACK-EMF, MOTOR DRIVING CONTROL APPARATUS AND METHOD USING THE SAME

(71) Applicant: SAMSUNG ELECTRO-MECHANICS CO., LTD., Suwon (KR)

(72) Inventors: Joo Yul KO, Gyunggi-do (KR); Soo Woong LEE, Gyunggi-do (KR)

(73) Assignee: SAMSUNG ELECTRO-MECHANICS CO., LTD., Suwon (KR)

(21) Appl. No.: 13/772,166

(22) Filed: Feb. 20, 2013

(30) Foreign Application Priority Data
Nov. 26, 2012 (KR) 10-2012-0134541

(51) Int. Cl. H02P 6/18

(52) U.S. Cl. CPC H02P 6/18
USPC 318/400.06

(57) ABSTRACT

There are provided a circuit for detecting back-electromotive force, a motor driving control apparatus and method using the same, the motor driving control apparatus including: a comparing unit outputting back-electromotive force of a motor apparatus using a plurality of comparators connected to a plurality of phases of the motor apparatus, respectively; a controlling unit controlling the driving of the motor apparatus using the back-electromotive force; and a comparator driving unit activating at least a portion of the plurality of comparators according to a preset operation scheduling.

### CROSS-REFERENCE TO RELATED APPLICATIONS

This application claims the priority of Korean Patent Application No. 10-2012-0134541 filed on Nov. 26, 2012, in the Korean Intellectual Property Office, the disclosure of which is incorporated herein by reference.

### BACKGROUND OF THE INVENTION

1. Field of the Invention

The present invention relates to a circuit for detecting back-electromotive force (back-EMF) capable of significantly reducing power consumption by selectively activating a portion of a plurality of comparators according to an operation scheduling of a motor apparatus, and a motor driving control apparatus and method using the same.

2. Description of the Related Art

In accordance with the development of motor technology, motors having various sizes have been used in a wide range of fields.

Generally, a motor is driven by rotating a rotor using a permanent magnet and a coil having polarities changed according to a current applied thereto. Initially, a brush type of motor in which a rotor is provided with a coil was provided. However, this motor has a problem such as abrasion of a brush, generation of a spark, or the like, due to driving of the motor.

Therefore, recently, various types of brushless motors have been generally used. In the brushless motor, a rotor is used as a permanent magnet and a stator is provided with a plurality of coils to induce rotation of the rotor.

In the case of the brushless motor as described above, it is necessary to confirm a position of the rotor. To this end, a scheme of using back-electromotive force (BEMF) has been widely used. In order to detect the back-electromotive force, a method of using a plurality of comparators for a plurality of phases of a multi-phase motor to detect the back-electromotive force has been used.

However, in the case of this method, a comparator in which the back-electromotive force is not detected should be operated, and switching of various kinds of reference signals should been performed on each of the phases in each of the plurality of comparators.

Therefore, since power consumed by the comparator has increased, driving efficiency of the motor apparatus has decreased.

The following Related Art Document relates to this motor apparatus. However, the above-mentioned limitations in detecting the back-electromotive force have been still present therein.

### RELATED ART DOCUMENT

(Patent Document 1) Korean Patent Laid-Open Publication No. 2006-0068844
(Patent Document 2) Japanese Patent Laid-open Publication No. 1995-031187

### SUMMARY OF THE INVENTION

An aspect of the present invention provides a circuit for detecting back-electromotive force (back-EMF) capable of significantly reducing power consumption by selectively activating a portion of a plurality of comparators according to an operation scheduling of a motor apparatus, and a motor driving apparatus and method using the same.

According to an aspect of the present invention, there is provided a motor driving control apparatus including: a comparing unit outputting back-electromotive force of a motor apparatus using a plurality of comparators connected to a plurality of phases of the motor apparatus, respectively; a controlling unit controlling the driving of the motor apparatus using the back-electromotive force; and a comparator driving unit activating at least a portion of the plurality of comparators according to a preset operation scheduling.

The plurality of comparators may receive back-electromotive force of the phase connected thereto and compare the received back-electromotive force with a predetermined reference signal to output the back-electromotive force, and determine whether or not they operate according to an activation signal provided by the comparator driving unit.

The comparator driving unit may provide an activation signal so that at least two comparators are simultaneously operated for at least a certain period of time.

The comparator driving unit may provide the activation signal to first and second comparators respectively, corresponding to a first phase currently operated and a second phase to be operated after the first phase.

The comparator driving unit may provide the activation signal to the second comparator after at least half of an operating period of the first phase has passed.

The comparator driving unit may electrically connect the reference signal for the second comparator when the comparator driving unit provides the activation signal to the second comparator.

When back-electromotive force is detected in a specific phase, the comparator driving unit may provide an inactivation signal to a comparator connected to the specific phase in which the back-electromotive force is detected.

According to another aspect of the present invention, there is provided a circuit for detecting back-electromotive force including: a comparing unit including a plurality of comparators connected to a plurality of phases of a motor apparatus, respectively; and a comparator driving unit activating at least a portion of the plurality of comparators according to a preset operation scheduling, wherein the plurality of comparators compare back-electromotive force detected in the plurality of phases with a predetermined reference signal to detect the back-electromotive force.

The comparator driving unit may provide an activation signal to first and second comparators respectively, corresponding to a first phase currently operated and a second phase to be operated after the first phase.

The comparator driving unit may electrically connect a reference signal for the second comparator when the comparator driving unit provides the activation signal to the second comparator.

When the back-electromotive force is detected from the first comparator, the comparator driving unit may provide an inactivation signal to the first comparator.

According to another aspect of the present invention, there is provided a motor driving control method performed in a motor driving control apparatus detecting back-electromotive force using a plurality of comparators connected to a plurality of phases of a motor apparatus, the motor driving control method including: determining first phase currently operated among the plurality of phases; determining a second phase to be operated after the first phase; and providing an activation signal activating a comparator connected to the second phase.

The motor driving control method may further include determining whether or not the phase commutation is generated and setting the second phase to a phase currently operated when the phase commutation is generated.

The providing of the activation signal may include providing the activation signal to the second comparator after at least half of an operating period of the first phase has passed.

The plurality of comparators may receive back-electromotive force of the phase connected thereto and compare the received back-electromotive force with a predetermined reference signal to output the back-electromotive force, and the providing of the activation signal may include electrically connecting the reference signal for the second comparator when the activation signal is provided to the second comparator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating an example of a motor driving control apparatus;

FIG. 2 is a reference diagram illustrating a comparing unit of the motor driving control apparatus of FIG. 1; FIG. 3 is a reference diagram illustrating scheduling of the comparing unit of the motor driving control apparatus of FIG. 1;

FIG. 4 is a configuration diagram illustrating an example of a motor driving control apparatus according to an embodiment of the present invention;

FIG. 5 is a reference diagram illustrating a comparing unit of the motor driving control apparatus of FIG. 4;

FIGS. 6 and 7 are reference diagrams illustrating scheduling of the comparing unit of the motor driving control apparatus of FIG. 4; and

FIG. 8 is a configuration diagram illustrating an example of a motor driving control method according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

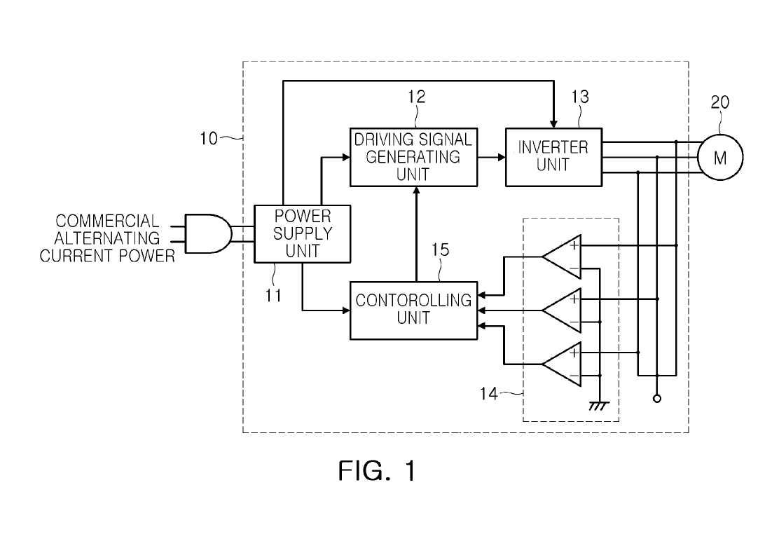

FIG. 1 is a configuration diagram illustrating an example of a motor driving control apparatus.

Referring to FIG. 1, the motor driving control apparatus 10 may include a power supply unit 11, a driving signal generating unit 12, an inverter unit 13, a comparing unit 14, and a controlling unit 15.

The power supply unit 11 may supply power to the respective components of the motor driving control apparatus 10. For example, the power supply unit 11 may convert a commercial alternating current (AC) voltage into a direct current (DC) voltage and supply the DC voltage to the respective components.

The driving signal generating unit 12 may provide a driving signal to the inverter unit 13. As an example, the driving signal may be a pulse width modulation (PWM) signal.

The inverter unit 13 may control an operation of a motor apparatus 20. For example, the inverter unit 13 may convert the DC voltage into a plural-phase (for example, a three-phase or a four-phase) voltage according to the driving signal and apply the plural-phase voltage to each of the coils of the motor apparatus 20 (not shown).

The comparing unit 14 may detect back-electromotive force of the motor apparatus 20. For example, the comparing unit 14 may include a plurality of comparators connected to the plurality of phases, respectively.

The controlling unit 15 may control the driving signal generating unit 12 to generate the driving signal using the back-electromotive force provided by the comparing unit 14. For example, the controlling unit 15 may control the driving signal generating unit 12 to perform phase commutation at a zero-crossing point of the back-electromotive force.

The motor apparatus 20 may perform a rotation operation according to the driving signal. For example, the motor apparatus 20 may generate magnetic fields in the respective coils (stators) of the motor apparatus 20 by currents provided by the inverter unit 13 and flowing in the respective phases. The rotor (not shown) included in the motor apparatus 200 may be rotated by the magnetic fields generated in the respective coils as described above.

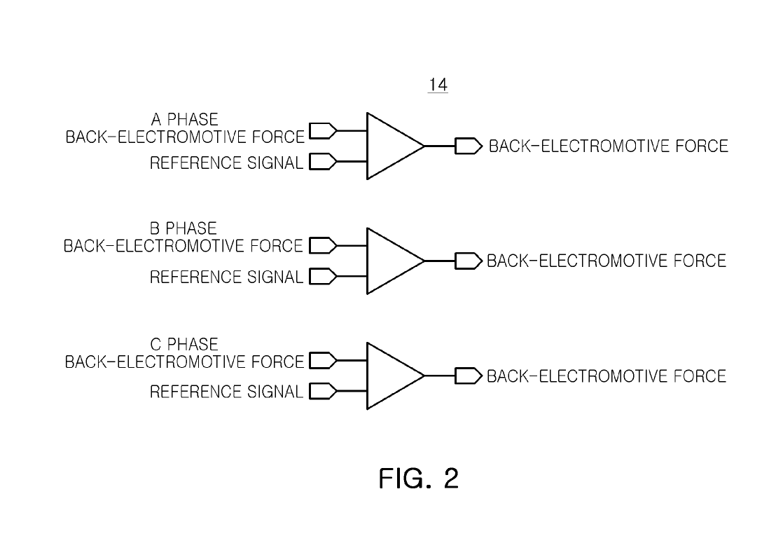

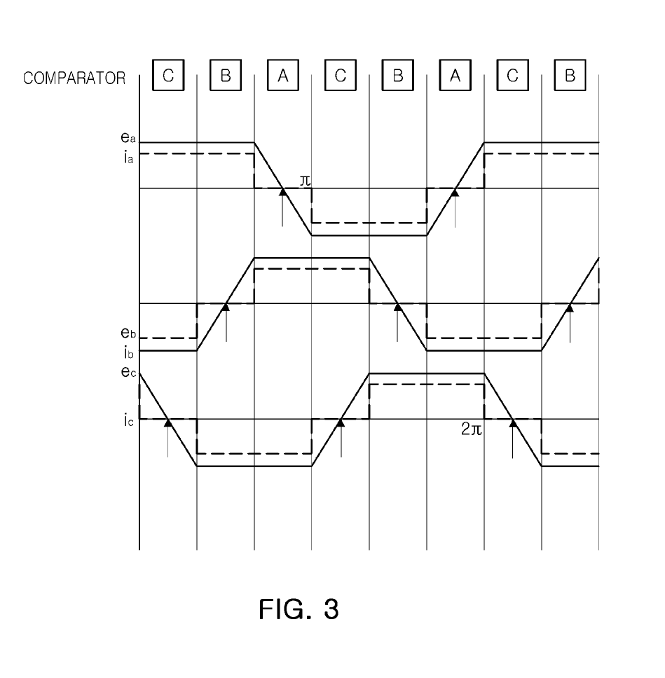

FIG. 2 is a reference diagram illustrating a comparing unit of the motor driving control apparatus of FIG. 1, and FIG. 3 is a reference diagram illustrating scheduling of the comparing unit of the motor driving control apparatus of FIG. 1.

Referring to FIG. 2, it may be appreciated that the comparing unit 14 is configured of the plurality of comparators and the plurality of comparators are electrically connected to the plurality of phases of the motor apparatus. Hereinafter, a three-phase motor will be described by way of example, but it may be obvious that a motor having different amounts of phases also corresponds to the present invention.

The respective comparators may receive back-electromotive force and reference signals (comparative reference voltage) of the corresponding phases and compare them with each other to output back-electromotive force. In addition, each of the plurality of comparators may be continually driven in an active state and receive different signals from each other as the reference signal. That is, the respective comparators may receive various kinds of reference signals according to each situation. For example, the comparator may receive various reference signals according to the situation such as VDD, GND, VDD/2, or the like.

FIG. 3 shows an operation scheduling of the phase currently driven and also shows that the comparator connected to the phase currently driven is operated.

That is, in the example shown in FIG. 3, it may be appreciated that the respective phases are operated in a sequence of a C phase, a B phase, and an A phase in each half-cycle (π). Therefore, output, that is, back-electromotive force of the comparator connected to the C phase, the comparator connected to the B phase, and the comparator connected to the A phase may be used sequentially.

It may be appreciated that the detected back-electromotive force eₐ is compared with a predetermined reference signal iₐ to be used to perform phase commutation based on a zero-crossing point (an arrow).

However, since the plurality of comparators as described above are still in a driving state (the active state) even at a section at which its own output is not needed, current may be unnecessarily consumed.

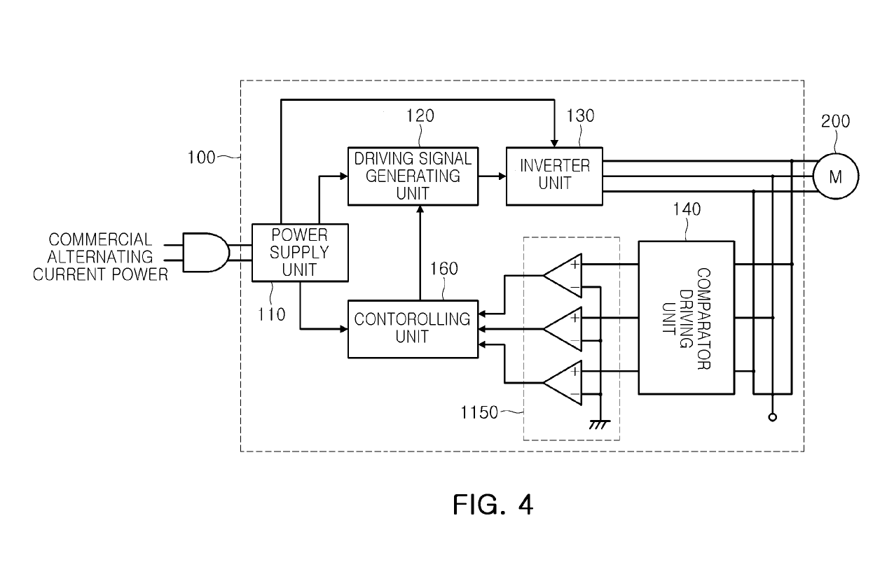

Hereinafter, various embodiments of the present invention will be described with reference to FIGS. 4 through 8. In a description of various embodiments of the present invention to be described below, overlapped descriptions of contents that are the same as or correspond to contents described above with reference to FIGS. 1 through 3 will be omitted. However, those skilled in the art may clearly understand detailed contents of the present invention from the above-mentioned description.

FIG. 4 is a configuration diagram illustrating an example of a motor driving control apparatus according to an embodiment of the present invention.

Referring to FIG. 4, the motor driving control apparatus 100 may include a power supply unit 110, a driving signal generating unit 120, an inverter unit 130, a comparator driving unit 140, a comparing unit 150, and a controlling unit 160.

The power supply unit 110 may supply power to the respective components of the motor driving control apparatus 100.

The driving signal generating unit 120 may generate a driving signal of a motor apparatus 200 according to a control of the controlling unit 160. For example, the driving signal generating unit 120 may generate a pulse width modulation signal (hereinafter, referred to as a PWM signal) having a predetermined duty ratio and provide the PWM signal to the inverter unit 130 to allow the motor apparatus 200 to be driven.

The inverter unit 130 may receive the driving signal to drive the respective phases of the motor apparatus 200.

The comparing unit 150 may detect back-electromotive force generated in the motor apparatus 200. More specifically, the comparing unit 150 may output the back-electromotive force from the motor apparatus 200 using a plurality of comparators respectively connected to a plurality of phases of the motor apparatus.

The comparator driving unit 140 may activate at least a portion of the plurality of comparators included in the comparing unit 150 according to a preset operation scheduling. Although the case in which the comparator driving unit 140 is positioned at a front end of the comparing unit 150 is shown in FIG. 4, the comparator driving unit 140 may be positioned at a rear end of or in parallel with the comparing unit 150.

That is, in the present invention, the comparator driving unit 140 may provide an activation signal to each of the comparators, and each comparator may be in the active state only in the case in which the activation signal is inputted thereto to thereby be driven.

In the embodiment of the present invention, the comparator driving unit 140 may provide the activation signal so that at least two comparators are simultaneously operated for at least a certain period of time. For example, the comparator driving unit 140 may provide the activation signal to first and second comparators respectively, corresponding to a first phase currently operated and a second phase that will be operated after the first phase.

In the embodiment of the present invention, the comparator driving unit 140 may determine an active time of the comparator operated later among the two comparators simultaneously operated to be at least a certain interval within an operation period. For example, the comparator driving unit 140 may provide the activation signal to the second comparator connected to the second phase operated next after at least half of the operation period of the first phase currently operated passes. More specifically, for example, in the case in which the comparator driving unit 140 provides the activation signal to the comparator of the second phase after 90% of the operating period of the first phase has passed, the second phase may receive the activation signal 10% early before its own operation period to prepare the driving. Therefore, overall, it may be appreciated that in the case in which the current is increased 1.1 times, all of the three phases may actually be driven according to their own timings, respectively.

In the embodiment of the present invention, the comparator driving unit 140 may perform a control to switch the reference signal of each of the comparators. For example, when the comparator driving unit 140 provides the activation signal to the second comparator operated thereafter, the comparator driving unit 140 may electrically switch the reference signal for the second comparator to connect the reference signal.

In the embodiment of the present invention, the comparator driving unit 140 may set the comparator connected to the phase in which the back-electromotive force is detected to an inactive state. For example, when the back-electromotive force is detected in a specific phase, the comparator driving unit 140 may provide an inactivation signal to the comparator connected to the specific phase in which the back-electromotive force is detected.

The controlling unit 160 may control the driving signal generating unit 120 to generate the driving signal using the back-electromotive force provided by the comparing unit 150.

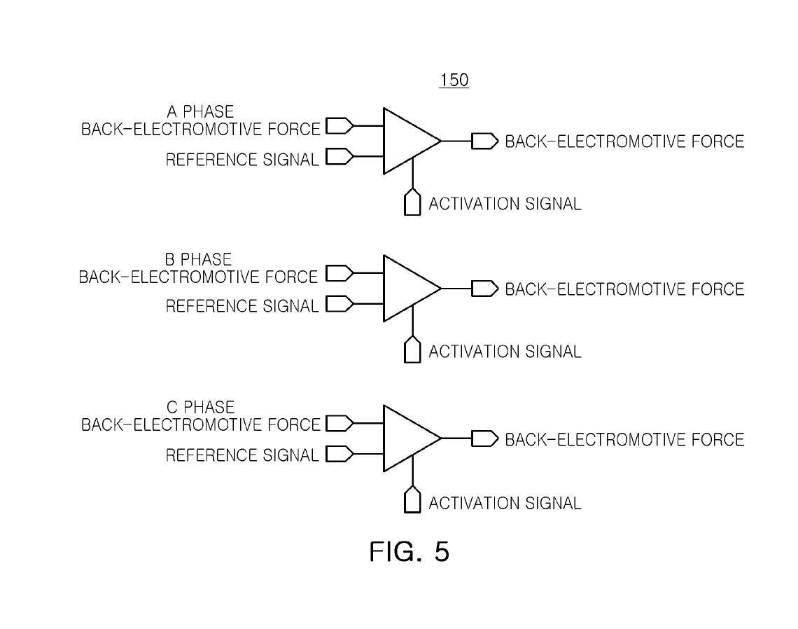

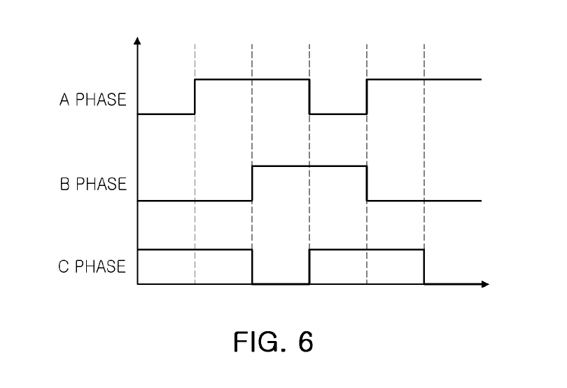

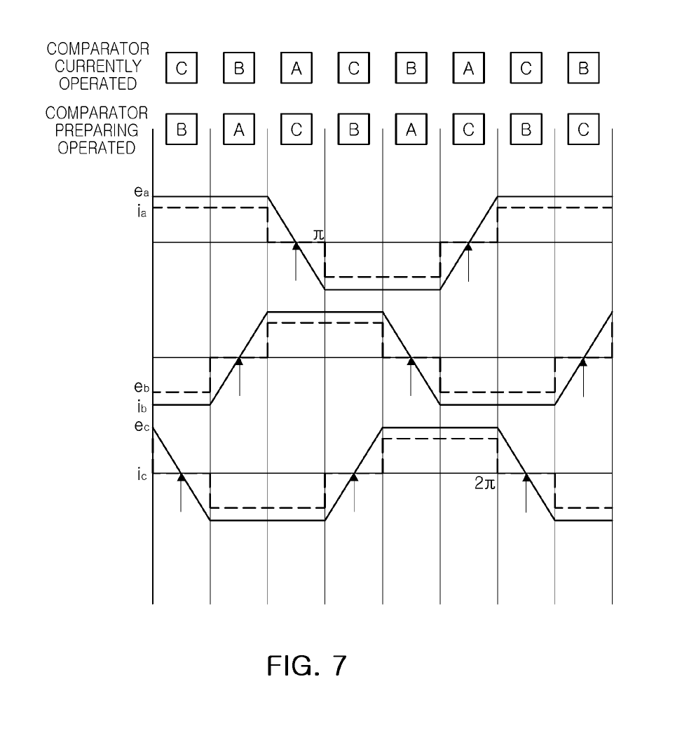

FIG. 5 is a reference diagram illustrating a comparing unit of the motor driving control apparatus of FIG. 4, and FIGS. 6 and 7 are reference diagrams illustrating scheduling of the comparing unit of the motor driving control apparatus of FIG. 4.

Hereinafter, a sequential scheduling of the plurality of comparators will be described with reference to FIGS. 5 through 7.

Referring to FIG. 5, it may be appreciated that each of the plurality of comparators included in the comparing unit 150 may receive the activation signal to perform an operation.

The comparator receives back-electromotive force of the phase connected thereto and comparing the received back-electromotive force with a predetermined reference signal to output back-electromotive force as described above. Particularly, the comparator according to the present invention may perform the operation when the activation signal is applied. That is, the comparator may determine whether or not it operates according to the activation signal provided by the comparator driving unit.

FIG. 6 shows an example of an activation signal of a three-phase comparator, and FIG. 7 shows scheduling of a comparator currently operated and a comparator preparing the next operation according to the activation signal of FIG. 6

As shown in FIGS. 6 and 7, initially, in the case in which the comparator of the C phase is currently operated, the activation signal may be provided to the comparator of the B phase, the next phase. Here, the activation signal may be provided before the operation of the comparator of the C phase is finished as described above. Therefore, in a state in which the C phase is currently operated, the comparator of the C phase currently operated and the comparator of the B phase to be operated next may be activated.

Similarly, in the case in which the comparator of the B phase is operated, the comparator of the C phase, a previous operation phase, becomes inactive, and the comparator of the A phase to be operated next may receive the activation signal.

The above-mentioned processes are repeatedly performed, such that the back-electromotive force eₐ may be stably detected while among the plurality of comparators, only at most two comparators are simultaneously operated. The detected back-electromotive force eₐ is compared with the predetermined reference signal iₐ to be used to perform phase commutation based on zero-crossing point (an arrow) as described above.

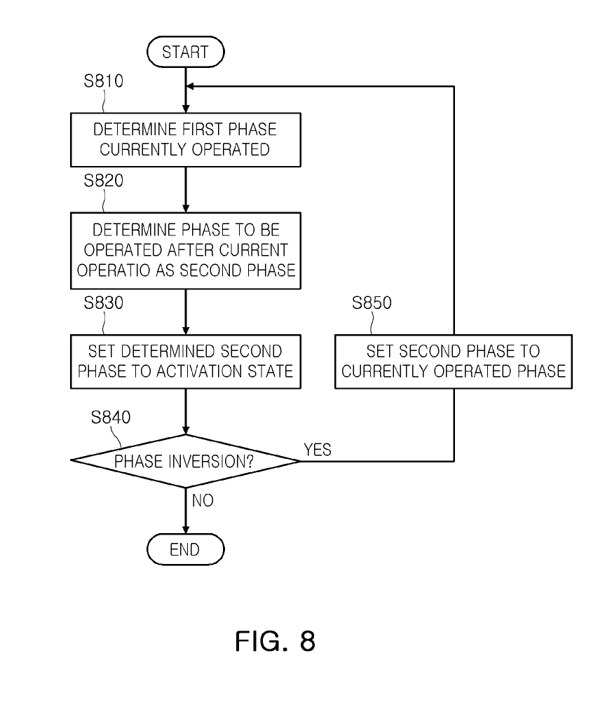

FIG. 8 is a flow chart illustrating an example of a motor driving control method according to the embodiment of the present invention.

Hereinafter, an example of a motor driving control method according to the embodiment of the present invention will be described with reference to FIG. 8. Since the example of the motor driving control method according to the embodiment of the present invention is performed in the motor driving control apparatus 100 described above with reference to FIGS. 4 through 7, an overlapped description of contents the same as or that correspond to the above-mentioned contents will be omitted.

Referring to FIG. 8, the motor driving control apparatus 100 may determine a first phase currently operated among the plurality of phases included in the motor apparatus (S810).

The motor driving control apparatus 100 may determine a second phase to be operated after the first phase (S820) and provide an activation signal activating a comparator connected to the second phase (S830).

The motor driving control apparatus 100 may judge whether or not phase commutation is generated (S840), set the second phase to the phase currently operated (S850) when the phase commutation is generated (S840, yes), and then repeatedly perform the above-mentioned processes S810 to S840.

In an example of S830, the motor driving control apparatus 100 may provide the activation signal to the second comparator after at least half of the operating period of the first phase has passed.

In another example of S830, the motor driving control apparatus 100 may electrically connect the reference signal for the second comparator when the motor driving apparatus 100 provides the activation signal to the second comparator.

As set forth above, according to the embodiment of the present invention, a portion of the plurality of comparators are selectively activated according to the operation scheduling of the motor apparatus, whereby the power consumption may be significantly reduced.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus comprising:
a comparing unit outputting back-electromotive force of a motor apparatus using a plurality of comparators connected to a plurality of phases of the motor apparatus, respectively;
a controlling unit controlling the driving of the motor apparatus using the back-electromotive force; and
a comparator driving unit activating at least a portion of the plurality of comparators according to a preset operation scheduling.

2. The motor driving control apparatus of claim 1, wherein the plurality of comparators receive back-electromotive force of the phase connected thereto and compare the received back-electromotive force with a predetermined reference signal to output the back-electromotive force, and determine whether or not they operate according to an activation signal provided by the comparator driving unit.

3. The motor driving control apparatus of claim 2, wherein the comparator driving unit provides an activation signal so that at least two comparators are simultaneously operated for at least a certain period of time.

4. The motor driving control apparatus of claim 3, wherein the comparator driving unit provides the activation signal to first and second comparators respectively, corresponding to a first phase currently operated and a second phase to be operated after the first phase.

5. The motor driving control apparatus of claim 4, wherein the comparator driving unit provides the activation signal to the second comparator after at least half of an operating period of the first phase has passed.

6. The motor driving control apparatus of claim 4, wherein the comparator driving unit electrically connects the reference signal for the second comparator when the comparator driving unit provides the activation signal to the second comparator.

7. The motor driving control apparatus of claim 1, wherein when back-electromotive force is detected in a specific phase, the comparator driving unit provides an inactivation signal to a comparator connected to the specific phase in which the back-electromotive force is detected.

8. A circuit for detecting back-electromotive force comprising:
a comparing unit including a plurality of comparators connected to a plurality of phases of a motor apparatus, respectively; and
a comparator driving unit activating at least a portion of the plurality of comparators according to a preset operation scheduling,
wherein the plurality of comparators compare back-electromotive force detected in the plurality of phases with a predetermined reference signal to detect the back-electromotive force.

9. The circuit for detecting back-electromotive force of claim 8, wherein the comparator driving unit provides an activation signal to first and second comparators respectively, corresponding to a first phase currently operated and a second phase to be operated after the first phase.

10. The circuit for detecting back-electromotive force of claim 9, wherein the comparator driving unit electrically connects a reference signal for the second comparator when the comparator driving unit provides the activation signal to the second comparator.

11. The circuit for detecting back-electromotive force of claim 9, wherein when the back-electromotive force is detected from the first comparator, the comparator driving unit provides an inactivation signal to the first comparator.

12. A motor driving control method performed in a motor driving control apparatus detecting back-electromotive force using a plurality of comparators connected to a plurality of phases of a motor apparatus, the motor driving control method comprising:
determining first phase currently operated among the plurality of phases;
determining a second phase to be operated after the first phase; and
providing an activation signal activating a comparator connected to the second phase.

13. The motor driving control method of claim 12, further comprising judging whether or not the phase commutation is generated and setting the second phase to a phase currently operated when the phase commutation is generated.

14. The motor driving control method of claim 12, wherein the providing of the activation signal includes providing the activation signal to the second comparator after at least half of an operating period of the first phase has passed.

15. The motor driving control method of claim 12, wherein the plurality of comparators receive back-electromotive force of the phase connected thereto and compare the received back-electromotive force with a predetermined reference signal to output the back-electromotive force, and
the providing of the activation signal includes electrically connecting the reference signal for the second comparator when the activation signal is provided to the second comparator.
